(19) United States
(12) Patent Application Publication
(10) Pub. No.: US 2022/0298067 A1
(43) Pub. Date: Sep. 22, 2022

(54) USE OF ANIMAL BY-PRODUCTS FOR CEMENT PRODUCTION

(71) Applicant: University of Kentucky Research Foundation, Lexington, KY (US)

(72) Inventors: Tristana Duvallet, Lexington, KY (US); Robert B. Jewell, Lexington, KY (US)

(21) Appl. No.: 17/696,714

(22) Filed: Mar. 16, 2022

Related U.S. Application Data
(60) Provisional application No. 63/163,486, filed on Mar. 19, 2021.

(51) Int. Cl. C04B 7/28; C04B 7/42

(52) U.S. Cl. CPC C04B 7/28; C04B 7/424; C04B 7/527

(57) ABSTRACT

A raw meal and clinker are provided based on animal by-products, such as bone ash. The resulting cement contains clinker phases such as: tricalcium phosphate (TCP), calcium sulfoaluminate (CSA), calcium aluminate phases (CA, CA₂, CA₆, C₁₂A₇, among others), hydroxyapatite (HA), and minor phases (anhydrite, lime, among others).

### RELATED APPLICATION

This application claims the benefit of U.S. Provisional Patent Application Ser. No. 63/163,486, filed on Mar. 19, 2021, and hereby incorporated by reference in its entirety.

### TECHNICAL FIELD

This document relates generally to the cement clinker field and, more particularly, to a new and improved raw meal for a cement clinker, a new and improved cement clinker made from that raw meal, a new and improved process for producing a cement clinker, and new and improved cement and mortar materials made from this cement clinker wherein the raw meal incorporates animal by-products

### BACKGROUND

Cement Notation

| Chemical | Cement |
|---|---|
| Formula | Notation |
| CaO | C |
| SiO₂ | S |
| Al₂O₃ | A |
| Fe₂O₃ | F |
| SO₃ | Ś |
| M | MgO |
| P | P₂O₅ |

| | Chemical | Cement |
|---|---|---|
| Names | Notation | Notation |
| Tricalcium phosphate-TCP | Ca₃(PO₄)₂ | C₃P |
| Hydroxyapatite-HA | Ca₁₀(PO₄)₆(OH)₂ | C₁₀P₃H |
| Tetracalcium Trialuminate Sulfate- | Ca₄Al₆(SO₄)O₁₂ | C₄A₃$ or C₄A₃Ś |
| Ye’elimite-CSA | | |
| Tricalcium aluminate | Ca₃Al₂O₄ | C₃A |
| Dodecacalcium hepta-aluminate-Mayenite | Ca₁₂Al₁₄O₃₃ | C₁₂A₇ |
| Monocalcium dialuminate-Grossite | CaAl₄O₇ | CA₂ |
| Monocalcium aluminate-Krotite | CaAl₂O₄ | CA |
| Monocalcium hexa-aluminate-Hibonite | CaAl₁₂O₁₉ | CA₆ |
| Calcium sulfate anhydrous-Anhydrite | CaSO₄ | C$ or CŚ |
| Calcium oxide-Free Lime | CaO | C |

The consumption of meat is increasing annually, generating globally 130 billion kg of meat and bone meal (MBM), which are considered inedible by-products. As such, they are reused as animal feed, fertilizer, or landfilled. All of these uses negatively impact society worldwide: risk of transmittable disease through animal feed and fertilizer (e.g. Mad Cow disease); risk of environmental issues through landfilling; and high cost of waste disposable which hampers the growth of global and local meat systems.

This document describes the use of animal by-products, such as bone ash (BA), as a raw material for the production of cement and concrete. This use provides a beneficial path for the disposal of those animal by-products. Further, by using animal by-products (bone ash) in place of at least some of the limestone used in state-of-the-art cement production processes, the cement industry's reliance on natural resources is reduced. Additionally, and perhaps most importantly, this is all accomplished while simultaneously allowing for a reduction in carbon dioxide (CO₂) emissions during the production of cement and concrete.

Additionally, it is noted in the biomedical field that state-of-the-art tricalcium phosphate (TCP) synthetic bone substitute is characterized by relatively low early compressive strength. In contrast, ye'elimite and TCP containing cement made from raw meal, as disclosed herein incorporating animal by-products, beneficially exhibits much higher early compressive strength and is potentially better adapted for use as a synthetic bone substitute.

### SUMMARY

This document describes a new and improved raw meal, incorporating animal by-products (more specifically, bone ash from animal bones), and the production of a novel clinker and cement made from that raw meal. The resulting clinker contains: tricalcium phosphate (TCP), calcium sulfoaluminate (ye'elimite, Klein's compound, or CSA), calcium aluminate phases (CA, CA₂, CA₆, C₁₂A₇, among others), hydroxyapatite (HA), and minor phases (anhydrite and lime, among others). The final cement can have applications as building products or as synthetic bone substitutes.

In accordance with the purposes and benefits described herein, a new and improved raw meal for a cement clinker comprises, consists of or consists essentially of: (a) about 20-70 weight percent calcium oxide; (b) about 0-15 weight percent silicon dioxide; (c) about 20-70 weight percent aluminum oxide; (d) about 0-15 weight percent iron oxide; (e) about 2.5-35 weight percent sulfur trioxide; (f) about 0-5 weight percent magnesium oxide; (g) about 0-5 weight percent sodium oxide; and (h) about 0-50 weight percent phosphorus pentoxide. The raw meal incorporates animal by-product as a component. In one or more of the many possible embodiments of the raw meal, that animal by-product is selected from a group of materials consisting of animal bone, bone ash and combinations thereof, or any raw materials with high contents of calcium oxide and phosphorus pentoxide. In one or more of the many possible embodiments of the raw meal, the raw meal further includes at least one of calcium hydroxide, limestone, hydrated lime, aluminum hydroxide, anhydrous calcium sulfate, hemihydrate calcium sulfate, dehydrate calcium sulfate, calcium fluoride, a mineralizer, and a flux. Other materials can be considered as a raw material as long as the final chemical composition of the raw meal fall within the ranges presented within this document.

In one or more of the many possible embodiments of the raw meal, the raw meal includes about 30-45 weight percent calcium oxide. In one or more of the many possible embodiments of the raw meal, the raw meal includes about 0-2.5 weight percent silicon dioxide. In one or more of the many possible embodiments of the raw meal, the raw meal includes about 30-50 weight percent aluminum oxide. In one or more of the many possible embodiments of the raw meal, the raw meal includes about 0-1 weight percent iron oxide. In one or more of the many possible embodiments of the raw meal, the raw meal includes about 5-15 weight percent sulfur trioxide. In one or more of the many possible embodiments of the raw meal, the raw meal includes about 0-1 weight percent magnesium oxide and 0-1 weight percent sodium oxide. In one or more of the many possible embodiments of the raw meal, the raw meal includes about 10-20 weight percent phosphorus pentoxide.

In accordance with an additional aspect, a cement clinker is made from the raw meal described in this document. That cement clinker comprises, consists of or consists essentially of: (a) about 10-80 weight percent calcium sulfoaluminate; (b) about 5-50 weight percent tricalcium phosphate; (c) about 0-75 weight percent calcium aluminates; and (d) about 0-25 weight percent minor phases including at least one of anhydrite calcium sulfate, hydroxyapatite and free lime.

In one or more of the many possible embodiments of the cement clinker, the cement clinker includes about 30-65 weight percent calcium sulfoaluminate. In one or more of the many possible embodiments of the cement clinker, the cement clinker includes about 20-40 weight percent tricalcium phosphate. In one or more of the many possible embodiments of the cement clinker, the cement clinker includes about 5-25 weight percent calcium aluminates. In one or more of the many possible embodiments of the cement clinker, the cement clinker includes about 0-10 weight percent minor phases including at least one of anhydrite calcium sulfate, hydroxyapatite, and free lime.

In accordance with yet another aspect, a process for producing a cement clinker comprises the steps of: (a) preparing a raw meal of about 20-70 weight percent calcium oxide, about 0-15 weight percent silicon dioxide, about 20-70 weight percent aluminum oxide, about 0-15 weight percent iron oxide, about 2.5-35 weight percent sulfur trioxide, about 0-5 weight percent magnesium oxide, about 0-5 weight percent sodium oxide, and about 0-50 weight percent phosphorus pentoxide; (b) compacting and forming pellets from the raw meal; (c) calcining the pellets at about 900-1,000° C. for about 15-120 minutes; (d) clinkering the pellets at about 1,100-1350° C. for about 15-120 minutes to produce clinkered pellets; and (e) quenching the clinkered pellets in air.

In accordance with one or more of the many possible embodiments, the process includes incorporating animal by-product into the raw meal. Further, the process may include the step of selecting the animal by-product from a group of animal by-products consisting of animal bones, bone ash and combinations thereof. In one or more of the many possible embodiments of the process, the process includes the step of calcining the pellets for about 30-90 minutes. In one or more of the many possible embodiments of the process, the process includes the step clinkering the pellets at about 1,200-1,300° C. for about 45-75 minutes.

In the following description, there are shown and described several preferred embodiments of the (a) raw meal, (b) the cement clinker made from the raw meal and (c) the process for producing the cement clinker. As it should be realized, the raw meal, the cement clinker and the process are capable of other, different embodiments and their several details are capable of modification in various, obvious aspects all without departing from the raw meal, the cement clinker and the process as set forth and described in the following claims. Accordingly, the descriptions should be regarded as illustrative in nature and not as restrictive.

### DETAILED DESCRIPTION

This document describes the production of a novel clinker and cement based on animal by-products, such as bone ash, at firing temperature of 1100-1350° C. The resulting cement contains clinker phases such as: tricalcium phosphate (TCP), calcium sulfoaluminate (CSA), calcium aluminate phases (CA, CA₂, CA₆, C₁₂A₇, among others), hydroxyapatite (HA), and minor phases (anhydrite, lime, among others). The final clinker has the following mineralogical composition:
10 to 90 wt. %, preferably 30-65 wt. % CSA (also called ye'elimite, Klein's compound, or C₄A₃$)
5-50, preferably 20-40 wt. % tricalcium phosphate (or TCP)
0-75 wt. %, preferably 5-25 wt. % calcium aluminates (include CA, CA₂, CA₆, and C₁₂A₇)
0-25 wt. %, preferably 0-10 wt. % minor phases (include anhydrite C$, hydroxyapatite, free lime)

According to this invention, the raw materials for the preparation of the raw meal of the clinker can be from any sources, as long as the final chemical composition falls within the ranges as described in Table 1.

TABLE 1
Recommended, preferred, and most preferred
chemical composition of the raw meal

| | Recommended | Preferred | Most preferred |
|---|---|---|---|
| CaO | 20-70 | 25-50 | 30-45 |
| SiO₂ | 0-15 | 0-5 | 0-2.5 |
| Al₂O₃ | 20-70 | 25-60 | 30-50 |
| Fe₂O₃ | 0-15 | 0-5 | 0-1 |
| SO₃ | 2.5-35 | 5-25 | 5-15 |
| MgO | 0-5 | 0-2.5 | 0-1 |
| Na₂O | 0-5 | 0-2.5 | 0-1 |
| P₂O₅ | 0-50 | 5-25 | 10-20 |

The list of the raw materials can include animal bones, bone ash or another source of phosphorous pentoxide, calcium hydroxide, limestone, hydrated lime, aluminum hydroxide, and calcium sulfate (anhydrous, hemihydrate, or dihydrate). Some mineralizers and fluxes can also be added such as CaF₂ as a source of fluoride. This list is not exhaustive and other raw materials of a type known in the art to be useful in real meal compositions for cement clinkers could be substituted.

A cement clinker made from the raw material disclosed herein may include (a) about 10-80 weight percent calcium sulfoaluminate; (b) about 5-50 weight percent tricalcium phosphate; (c) about 0-75 or 0.1-75 weight percent calcium aluminates; and (d) about 0-25 or 0.1-25 weight percent minor phases including at least one of anhydrite calcium sulfate, hydroxyapatite, and free lime.

More specifically, the clinker may include: (a) about 30-65 weight percent calcium sulfoaluminate, (b) about 20-40 weight percent tricalcium phosphate, (c) about 5-25 weight percent calcium aluminates, and (d) about 0-10 or 0.1-10 weight percent minor phases including at least one of anhydrite calcium sulfate, hydroxyapatite, and free lime.

The process for producing the cement clinker includes the steps of: (a) preparing a raw meal of about 20-70 weight percent calcium oxide, about 0-15 weight percent silicon dioxide, about 20-70 weight percent aluminum oxide, about 0-15 weight percent iron oxide, about 2.5-35 weight percent sulfur trioxide, about 0-5 weight percent magnesium oxide, about 0-5 weight percent sodium oxide, and about 0-50 weight percent phosphorus pentoxide; (b) compacting and forming pellets from the raw meal; (c) calcining the pellets at about 900-1,000° C. for about 15-120 minutes; (d) clinkering the pellets at about 1,100-1350° C. for about 15-120 minutes to produce clinkered pellets; and (e) quenching the clinkered pellets in air. In other embodiments, the raw meal includes about 0.1-15 weight percent silicon dioxide, about 0.1-15 weight percent iron oxide, about 0.1-5 weight percent magnesium oxide, about 0.1-5 weight percent sodium oxide, and/or about 0.1-50 weight percent phosphorus pentoxide.

The process further includes one or more of the steps of: (a) incorporating animal by-product into the raw meal, (b) selecting the animal by-product from a group of animal by-products consisting of animal bone, bone ash and combinations thereof, or any raw materials with high contents of calcium oxide and phosphorus pentoxide, (c) calcining the pellets for about 30-90 minutes and (d) clinkering the pellets at about 1,200-1,300° C. for about 45-75 minutes.

The final clinker should be finely ground with a final particle size distribution with a d(50) of around 5-20 μm, preferably between about 6-15 μm. The final clinker should be mixed with a source of calcium sulfate (either calcium anhydrite, calcium hemihydrate, or calcium dihydrate). The optimal quantity of calcium sulfate should be determined by calorimetry studies, and/or calculated by taking into account all the clinker phases reacting with calcium sulfate during the hydration process, which include CSA and calcium aluminate clinker phases. Admixtures, such as citric acid and lithium carbonate, can also be added to the cement to accelerate or slow down the hydration process.

### EXPERIMENTAL SECTION

### Example 1

### Production of TCP-CSA Clinkers with Bone ash as Substitution for Calcium Hydroxide as Raw Material

The raw materials used for this example are all finely ground materials (with a d(50) below 20 μm) and include calcium hydroxide, bone ash, aluminum hydroxide, and calcium sulfate hemihydrate. The chemical composition of the bone ash is presented in Table 2, and the amounts for the six compositions tested in the Example 1 are detailed in Table 3. The compositions were selected to study the optimal replacement rate of calcium hydroxide with bone ash to produce TCP-CSA clinker.

TABLE 2
Chemical composition of bone ash used for the production of theoretical highly pure
CSA clinker (in wt. %)

| Sample | SiO₂ | Al₂O₃ | Fe₂O₃ | CaO | MgO | Na₂O | K₂O | P₂O₅ | TiO₂ | SO₃ | LOI |
|---|---|---|---|---|---|---|---|---|---|---|---|
| Bone Ash | 2.01 | 0.85 | 0.08 | 53.12 | 1.19 | 0.88 | 0.06 | 40.60 | 0.02 | 0.16 | 0.14 |

TABLE 3
Raw materials and amounts (in wt. %) used for the production of theoretical
highly pure CSA clinker with bone ash

| Compositions | Pure | 1% | 5% | 10% | 20% | 26.7% |
|---|---|---|---|---|---|---|
| Ca(OH)₂ | 26.7 | 25.7 | 21.7 | 16.7 | 6.7 | — |
| Bone Ash | — | 1 | 5 | 10 | 20 | 26.7 |
| Al(OH)₃ | 55.3 | | | | | |
| CaSO₄.0.5H₂O | 18 | | | | | |

The raw materials are blended in a mortar and pestle or in a ball mill (depending on the amount to blend) until complete homogenization. The raw meal is then pressed into pellets (57×7 mm) with some deionized water (10 wt. %) and a pressure of 44 MPa. The pellets are dried in an oven overnight at 60° C.

The pellets are placed in a kiln on an alumina plate covered with zirconium oxide powder to avoid interaction with the alumina plate. The samples are clinkered at 1250° C. for 60 minutes, quenched, and crushed in a shatter box for XRD/Rietveld analyses. (Table 4)

Several observations can be deduced from the Rietveld analyses presented in Table 4. First of all, the replacement of a small amount of calcium hydroxide with bone ash (composition 1%), related to the addition of a small amount of phosphorous, enhances the formation of ye'elimite, from 70 wt. % to 87 wt. %. Also, further replacing calcium hydroxide with bone ash results in a decrease in ye'elimite content while the contents of tricalcium phosphate (TCP), grossite (CA₂), and hibonite (CA₆) increase. CA₆ is not recognized as a hydraulically active clinker phase, and thus should be avoided within the final clinker.

TABLE 4
Rietveld analyses of compositions (in wt. %) presented in Table 3.

| | Pure | 1% | 5% | 10% | 20% | 26.7% |
|---|---|---|---|---|---|---|
| Ref Number | 78544 | 78545 | 78547 | 78549 | 78632 | 78633 |
| CSA | 70.4 | 86.8 | 59.8 | 49.7 | 23.8 | 8.2 |
| TCP | — | — | 3.2 | 9.4 | 24.7 | 33.1 |
| Hydroxyapatite | — | — | — | — | 0.2 | 0.4 |
| CA | 6.3 | 2.8 | 17.8 | 0.4 | 0.3 | 0.1 |
| CA₂ | 6.9 | 3.3 | 12.4 | 33.5 | 43.1 | 32.3 |
| C₁₂A₇ | 5.5 | 1.6 | 0.1 | 0.2 | 0.2 | 0.2 |
| CA₆ | — | — | 1.1 | 1.6 | 7.6 | 25.5 |
| c-C₃A | — | — | — | — | 0.1 | 0.2 |
| C$ | 8.8 | 5.0 | 4.4 | 3.0 | — | — |
| C | 2.0 | 0.5 | 0.2 | — | — | — |
| SiO₂ | — | — | 1.0 | 2.1 | — | — |
| Rwp | 8.09 | 7.93 | 7.14 | 7.23 | 7.16 | 7.30 |

### Example 2

### Production of TCP-CSA Clinker with Bone Ash as Raw Material

The bone ash used for the following composition is similar to the one presented in Example 1. Three compositions were produced and are presented in Table 5, and the Rietveld results are presented in Table 6.

These three compositions demonstrate the successful production of clinker composed of both CSA and TCP clinker phases, among other phases such as HA and calcium aluminate phases.

TABLE 5
Raw materials and amounts (in wt. %) used for
the production of TCP-CSA clinkers with bone ash

| Compositions | BO #1 | BO #2 | BO #3 |
|---|---|---|---|
| Ref Number | 80110 | 80111 | 80112 |
| Ca(OH)₂ | 15 | 25 | 22 |
| Bone Ash | 35 | 20 | 10 |
| Al(OH)₃ | 40 | 40 | 55 |
| CaSO₄.0.5H₂O | 10 | 15 | 13 |

TABLE 6
Rietveld analyses of compositions presented in Table 5

| | BO #1 | BO #2 | BO #3 |
|---|---|---|---|
| Ref Number | 80110 | 80111 | 80112 |
| CSA | 41.2 | 72.1 | 58.8 |
| TCP | 37.3 | — | 9.6 |
| Hydroxyapatite | 6.5 | 20.6 | 1.6 |
| CA | 10.2 | 1.4 | 15.2 |
| CA₂ | 3.9 | 0.2 | 12.0 |
| C₁₂A₇ | — | 1.7 | 0.2 |
| CA₆ | 0.7 | 0.5 | 1.1 |
| c-C₃A | — | — | — |
| C$ | — | — | 0.5 |
| C | 0.1 | 3.5 | 0.1 |
| SiO₂ | 0.1 | — | 0.9 |
| Rwp | 5.83 | 8.95 | 6.08 |

### Example 3

### Compressive Strength Results

Some mechanical properties were determined for a few samples produced in Example 1. Compressive strength samples were produced by mixing 225 g of compositions 10% and 20% (Example 1) with 25 g of FGD gypsum, 687.5 g of ASTM sand, and 121 g of deionized water. The mixing procedure followed ASTM C109. The mortars were placed in 4 cm cube molds and moved in a high humidity curing room for 24 hours. The mortar samples were then demolded and tested for compressive strength (Table 7) after 1, 7, and 27 days.

TABLE 7
Compressive strength of samples 10% and 20% from Example 1

| Sample name from Example 1 | 1-day | 7-day | 27-day |
|---|---|---|---|
| 10% | 54.5 | 57.4 | 52.6 |
| 20% | 38 | 45.7 | 27.9 |

### Example 4

### For Biomedical Purposes

Cement made from the cement clinker may be used for biomedical purposes, for example as synthetic bone substitutes. However, additional additives should be added to conform to ISO-10993-1 “Biological evaluation of medical devices” [11], ISO 5833:2002 Implants for surgery, ASTM F451-16, as well as any other standards related to synthetic bones.

Toward this end, small paste samples were produced following ASTM F451 for compressive strength analysis for testing for acrylic bone cement. Special compressive specimen molds were fabricated consisting of 48 hole-cylinders 12 mm high and 6 mm in diameter. They were tested for compressive strength, and preliminary results exceeded both commercial OPC and CSA cements after 24 hours: 19.8 MPa for commercial OPC, 37 MPa for commercial CSA, and 42 MPa for composition with 10% bone ash (similar cement to the one presented in Example 1).

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a mineralizer”, as used herein, may also refer to, and encompass, a plurality of mineralizers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the raw meal for making a cement clinker, the cement clinker made from that raw meal and the process for producing the cement clinker of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A raw meal of a cement clinker, comprising:
about 20-70 weight percent calcium oxide;
about 0-15 weight percent silicon dioxide;
about 20-70 weight percent aluminum oxide;
about 0-15 weight percent iron oxide;
about 2.5-35 weight percent sulfur trioxide;
about 0-5 weight percent magnesium oxide;
about 0-5 weight percent sodium oxide; and
about 0-50 weight percent phosphorus pentoxide.

2. The raw meal of claim 1 incorporating animal by-product.

3. The raw meal of claim 2, wherein that animal by-product is selected from a group consisting of animal bones, bone ash and combinations thereof, or any material with high contents of calcium oxide and phosphorus pentoxide.

4. The raw meal of claim 3, further including at least one of calcium hydroxide, limestone, hydrated lime, aluminum hydroxide, anhydrous calcium sulfate, hemihydrate calcium sulfate, dehydrate calcium sulfate, calcium fluoride.

5. The raw meal of claim 4, including about 30-45 weight percent calcium oxide.

6. The raw meal of claim 5, including about 0-2.5 weight percent silicon dioxide.

7. The raw meal of claim 6, including about 30-50 weight percent aluminum oxide.

8. The raw meal of claim 7, including about 0-1 weight percent iron oxide.

9. The raw meal of claim 8, including about 5-15 weight percent sulfur trioxide.

10. The raw meal of claim 9, including about 0-1 weight percent magnesium oxide and about 0-1 weight percent sodium oxide.

11. The raw meal of claim 10, including about 10-20 weight percent phosphorus pentoxide.

12. A cement clinker made from the raw meal of claim 2.

13. A cement clinker, comprising:
about 10-90 weight percent calcium sulfoaluminate;
about 5-50 weight percent tricalcium phosphate;
about 0-75 weight percent calcium aluminates; and
about 0-25 weight percent minor phases including at least one of anhydrite calcium sulfate, hydroxyapatite and free lime.

14. The cement clinker of claim 13, including about 30-65 weight percent calcium sulfoaluminate.

15. The cement clinker of claim 14, including about 20-40 weight percent tricalcium phosphate.

16. The cement clinker of claim 15, including about 5-25 weight percent calcium aluminates.

17. The cement clinker of claim 16, including about 0-10 weight percent minor phases including at least one of anhydrite calcium sulfate, hydroxyapatite and free lime.

18. A process for producing a cement clinker, comprising:
preparing a raw meal of about 20-70 weight percent calcium oxide, about 0-15 weight percent silicon dioxide, about 20-70 weight percent aluminum oxide, about 0-15 weight percent iron oxide, about 2.5-35 weight percent sulfur trioxide, about 0-5 weight percent magnesium oxide, about 0-5 weight percent sodium oxide, and about 0-50 weight percent phosphorus pentoxide;
compacting and forming pellets from the raw meal;
calcining the pellets at about 900-1,000° C. for about 15-120 minutes;
clinkering the pellets at about 1,100-1350° C. for about 15-120 minutes to produce clinkered pellets; and
quenching the clinkered pellets in air.

19. The process of claim 18, including incorporating animal by-product into the raw meal.

20. The process of claim 19, including selecting the animal by-product from a group of animal by-products consisting of animal bones, bone ash and combinations thereof.

21. The process of claim 20, including calcining the pellets for about 30-90 minutes.

22. The process of claim 21, including clinkering the pellets at about 1,200-1,300° C. for about 45-75 minutes.
